(19) United States
(12) Patent Application Publication
(10) Pub. No.: US 2010/0183115 A1
(43) Pub. Date: Jul. 22, 2010

(54) SYSTEM AND METHOD FOR ACQUIRING IMAGE DATA

(75) Inventors: Udo Van Stevendaal, Ahrensburg (DE); Jens-Peter Schlomka, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/376,584

(22) PCT Filed: Aug. 7, 2007
(86) PCT No.: PCT/IB07/53110

§ 371 Date: Feb. 6, 2009

(30) Foreign Application Priority Data
Aug. 11, 2006 (EP) 06118835.5

(51) Int. Cl. H05G 1/60

(52) U.S. Cl. 378/6; 378/9

(57) ABSTRACT

A Computer Tomography system for examining an object is disclosed. The system comprises a first X-ray tube, a second X-ray tube, a first X-ray detection unit and a second X-ray detection unit. Preferably, the first X-ray detection unit is adapted to acquire a first data set by detecting radiation emitted by the first X-ray tube after passing through the object under examination, and the second X-ray detection unit is adapted to acquire a second data set by detecting radiation emitted by the second X-ray tube after being scattered by the object under examination. The system has particular application to the field of baggage inspection.

### FIELD OF THE INVENTION

This invention relates to X-Ray apparatus and methods for acquiring image data, and has particular application to Coherent Scatter Computed Tomography apparatus for application in the fields of baggage inspection and medical scanning.

### BACKGROUND OF THE INVENTION

Systems for producing an image of a physical object are widespread in several technical fields. One area of particular commercial interest is that of fast baggage scanners that can be used in a number of scenarios, but are often particularly used to scan airline baggage. Another area of particular commercial interest is in the field of medical scanners. Beside the already known and widespread Computer Tomography (CT) devices a relatively new field of so-called Scattering Computer Tomography devices is developing.

For example, WO 2006/027756 discloses that the interaction of X-ray photons with matter in a certain energy range between 20 and 150 keV for instance, can be described by photoelectric absorption and scattering. Two different types of scattering exist: incoherent or Compton-scattering on the one hand, and coherent or Rayleigh-scattering on the other hand. Whereas Compton-scattering varies slowly with angle, Rayleigh-scattering is strongly forward directed and has a distinct structure, characteristic of each type of material. Furthermore, coherent X-ray scattering is a common technique or tool used in X-ray crystallography or X-ray diffraction when analyzing the molecular structure of materials in the semiconductor industry. The molecular structure function obtained provides a fingerprint of the material and allows good discrimination. For example, plastic explosives can be distinguished from harmless food products.

For medical use as well as for baggage inspection, attenuation of transmitted radiation, not scattering, is generally used in commercial Computer Tomography (CT) scanners and C-arm systems. These systems use a variety of calculation techniques to calculate from measured X-ray data the X-ray absorption properties of the sample at different locations in the sample, rather than simply provide an X-ray image of the sample as in conventional X-ray imaging.

Although Coherent Scattering Computer Tomography (CSCT) is a very promising technique, problems exist when applying it to the field of baggage inspection. For example, such applications place stringent and demanding requirements in relation to throughput, dark alarms and findings.

Hence there is a desire to improve upon known CT/CSCT systems and methodologies.

### SUMMARY OF THE INVENTION

According to a first aspect of the invention, a Computer Tomography system for examining an object is provided, comprising a first X-ray tube, a second X-ray tube, a first X-ray detection unit and a second X-ray detection unit, wherein the first X-ray detection unit is adapted to acquire a first data set by detecting radiation emitted by the first X-ray tube after passing through the object under examination, wherein the second X-ray detection unit is adapted to acquire a second data set by detecting radiation emitted by the second X-ray tube and after being scattered by the object under examination, wherein the first X-ray tube, the second X-ray tube, the first X-ray detection unit and the second X-ray detection unit are rotatable around the object under examination, and wherein the first X-ray tube, the second X-ray tube, the first X-ray detection unit and the second X-ray detection unit are rotatable around a common axis.

According to a second aspect of the invention, a method for acquiring image data of an object under examination is provided, which method uses a Computer Tomography system which comprises a first X-ray tube, a second X-ray tube, a first X-ray detection unit, and a second X-ray detection unit, wherein first X-ray detection unit is adapted to acquire a first data set by detecting radiation emitted by the first X-ray tube after passing through the object under examination, wherein the second X-ray detection unit is adapted to acquire a second data set by detecting radiation emitted by the second X-ray tube and after being scattered by the object under examination, wherein the first X-ray tube, the second X-ray tube, the first X-ray detection unit and the second X-ray detection unit are rotatable around the object under examination, and wherein the first X-ray tube, the second X-ray tube, the first X-ray detection unit and the second X-ray detection unit are rotatable around a common axis. The method comprises acquiring a first data set indicative of the object under examination by the first detection unit and acquiring a second data set indicative of the object under examination by the second detection unit.

According to a further aspect of the invention, a computer readable medium is provided in which a program for acquiring image data of an object under examination is stored, which program, when executed by a processor, causes said processor to carry out a method aspect of the invention.

According to yet a further aspect of the invention, a computer program for acquiring image data of an object under examination is provided, which program, when executed by a processor, causes said processor to carry out a method aspect of the invention.

In an embodiment a Computer Tomography system is provided which comprises two X-ray tubes and two X-ray detection units on a single gantry, in which one X-ray tube and detector are used for a CT measurement, and the second X-ray tube and detector are used for the detection of scattering. Such a system having two X-ray tubes advantageously enables independent adjustment of two different scanner (i.e. X-ray tubes and corresponding X-ray detectors) coordinate systems to find the same slices within baggage. It may be said that the Computer Tomography system according to this embodiment comprises two different scanning units. Furthermore, no transport of the baggage from the first scanner, a so-called pre-scanner, to the second scanner via a conveyor belt is necessary when providing a Computer Tomography system having two scanning units, advantageously avoiding the occurrence of different orientations of objects within the baggage during transport. In particular, it may be possible to use two different X-ray tubes, i.e. X-ray tubes which are tailored to specific different X-ray detection unit and/or detection principles. This tailoring may, for example, be in reference to the energy spectrum and/or radiation intensity.

The use of two different X-ray tubes is advantageous over a Computer Tomography system comprising only one X-ray tube but two detection units, which may be a standard X-ray detector and a coherently scattering Computer Tomography detection unit, since the two independent set-ups for the first scanning unit, e.g. standard CT scanning system, and the second scanning unit, e.g. a coherently scattering Computer Tomography, may be optimized individually without interference regarding spectrum, power, collimation and scatter angle.

This may also simplify each of the set-ups, e.g. regarding the primary beam collimation. Typical scatter angles in the diffractive scanning unit may be between 1° and 5°. The CT tube may have a tungsten anode spectrum while the acceleration voltage may be between 140 kV and 180 kV by a typical power between 2 kW and 3 kW. Additionally a 2 mm aluminium filter and possibly a 0.5 mm to 1 mm Cu filter may be used. The collimation may be adapted to form a fan beam or a cone beam depending on the used detector units. The focal spot of the radiation source may be in the about several mm wide and high. This may be securable by arranging the same on a single gantry, but may also be secured by corresponding arrangement on more than one gantry or supporting element and the corresponding controlling of these supporting elements.

In the following, further embodiments of the aforementioned aspects of the invention will be described.

In an embodiment of the Computer Tomography system the first X-ray detection unit comprises a plurality of detector elements, and/or the second X-ray detection unit comprises a plurality of detector elements.

For example, the first X-ray detection unit may be formed by integrating detector elements, while the second one may be formed by energy-resolving detector elements. The first X-ray tube and the first X-ray detection unit may form a first scanning system which may be adapted to perform standard Computer Tomography (CT), while the second X-ray tube and the second X-ray detection unit may form a second scanning system which may be adapted to perform coherently scattering Computer Tomography, thus forming a so-called CSCT scanner. Preferably, the X-ray tube used for CSCT is a so-called high-power tube, i.e. exhibits higher radiation intensity than that required by the X-ray tube for the standard CT. In this application the term “standard CT” is used to describe a CT which comprises a scanning unit which is adapted to detect radiation which passed through the object under examination, i.e. a system in which the X-ray tube and the corresponding X-ray detection unit are arranged opposed to each other having the object under examination in between.

In the above embodiment where one of the scanning systems or scanning units is formed as a CSCT the corresponding X-ray detection unit is preferably arranged offset with respect to the direct path of the radiation, which direct path passing through the object, wherein the offset is in the direction of the axis of rotation, in order to detect scattered radiation rather than the direct radiation which is attenuated by passing through the object under examination.

A combination of two X-ray tubes, one adapted for standard CT and one adapted for CSCT, as proposed by an embodiment of the invention, may be in particular advantageous over a conventional CT system in which one X-ray tube is used for both scanning units since such a conventional system in general comprises a fixed fan-beam collimator and is usually only capable of performing single slice CT which may not prove practical for high-throughput applications. However, according to this conventional technique, after finding a possible threat by a (helical) CT scan, the baggage must be conveyed back in order to investigate the suspicious region again, which on one side reduces the throughput and on the other side imposes the problem that by this conveying the object or the region in the object may be re-oriented so that a matching of the images and/or identification of the region may be made more difficult.

By using two different X-ray tubes, as proposed by an embodiment of the present invention, each tailored to the specific application, this disadvantage of the conventional systems may be overcome. Furthermore, by using two different X-ray tubes it may be possible to tailor both to different collimation, one adapted to CT and one adapted to CSCT which are in general different. Thus, according to an embodiment of the invention it may be possible to spare the provision of a moveable primary beam detector. Also the different optimal X-ray spectra and power requirements for the CT and CSCT system may be easily taken into account by using two X-ray tubes. Furthermore, geometrical limitation, e.g. a very closely mounting of the two X-ray detection units, which may be imposed on the mounting of the scattering detectors in such a system having only one X-ray tube may be overcome by using two different X-ray tubes as proposed by the present invention.

Further, the additional weight which is introduced by the CT according to the invention may not be exceptionally high since the two tailored detection units and a high-power X-ray tube are already necessary in every combination of CT and CSCT scanning units, thus only the second X-ray tube imposes additional weight.

According to another embodiment, the Computer Tomography system further comprises a high voltage generator which voltage generator is adapted to supply power to operate the first X-ray tube and is further adapted to supply power to operate the second X-ray tube. In this embodiment the two X-ray tubes share the same voltage generator so that additional weight is minimised, with the consequent advantage that any additional load to a gantry is reduced and may be more equally distributed on the gantry.

According to another embodiment the Computer Tomography system further comprises a gantry, and the first X-ray tube, the second X-ray tube, the first X-ray detection unit and the second X-ray detection unit are mounted on the gantry. That is, both scanners are mounted on the same gantry, which provides the advantage that the coordinate systems of the two scanners or scanning units are fixed relative to each other, so that matching of images reconstructed by the corresponding scanners may be easily matched to each other. Furthermore, the complexity of the CT system and of the controlling of the CT system may be simplified.

Alternatively, rotation around a common axis may also be secured by providing a corresponding arrangement on more than one gantry or supporting element and the corresponding control of these supporting elements.

According to another embodiment of the Computer Tomography system, the first X-ray tube and the second X-ray tube are displaced relative to each other. In particular, the displacement can be in the direction of the common axis. This common axis usually is called the z-direction and is substantially perpendicular to the x-y plane in which the X-ray tubes and X-ray detection units rotate.

When introducing such an offset in the z-direction, the standard CT scanning is arranged as the first scanning unit, whilst the CSCT scanning unit is arranged as the second scanning unit, i.e. the object under examination is scanned first by the standard CT scanning unit and afterwards by the CSCT scanning unit. Such an arrangement may lead to the advantage that a fast first scan by the standard CT can be performed and afterwards suspicious regions identified by the first standard CT scan can be further investigated by the second CSCT scanning unit.

This may lead to an increased throughput since only suspicious objects may be investigated by the CSCT scanning unit which has in general a lower throughput. It might as well be possible to provide a bypass for objects which are determined to not being suspicious by the CT scanning unit. Placing of two X-ray tubes with a certain distance to each other concerning the z-direction may lead to the advantage that suspicious regions discovered by a CT scan can be investigated by a consecutive CSCT scan without transporting the baggage backward. This may assure a relatively high throughput. Furthermore, the system may have an inherent conformance of the investigated suspicious slices. No further registration caused by two different systems may be necessary.

According to another embodiment of the Computer Tomography system, the displacement is in a radial direction with reference to the rotation. This direction is in general called radial direction or r-direction in the coordinate system of cylindrical coordinates. When using such a radial displacement of the two scanning units relative to each other the X-ray tube (source) and the corresponding X-ray detection unit which are part of the CSCT scanning unit are preferably arranged further away from the axis of rotation than the other X-ray tube and the X-ray detection unit belonging to the CT scanning unit, i.e. CSCT scanning unit are rotated along a circle having a greater radius than the CT scanning unit. This may lead to the advantage that the path of the radiation scattered by the object under examination is longer between the object and the X-ray detection unit, so that the angular resolution of the CSCT scanning unit may be increased which may lead to an improved reconstructed image.

According to another embodiment, of the Computer Tomography system the displacement is in the Φ-direction. Herein the Φ-direction relates to Φ-direction of cylindrical coordinates, i.e. is the direction which is perpendicular to the z-direction the direction of the common axis, and perpendicular to the radial direction. The displacement in Φ-direction may be between 60° and 120°, preferably the displacement is substantially 90°. A displacement of 90° may have the advantage that the weight is rather evenly distributed on a common gantry.

According to another embodiment, the Computer Tomography system further comprises a transporting device adapted to transport the object under examination through a region around which the first X-ray tube, the second X-ray tube, the first X-ray detection unit and the second X-ray detection unit are rotatable. Such a transport device may be a conveyor belt onto which the object under examination is laid upon. By providing a conveyor belt for transporting it may be possible to ensure that the orientation of the object under examination is not changed while transporting the object from the CT scanning unit to the CSCT scanning unit, which may simplify a necessary matching of the corresponding reconstructed images.

According to another embodiment, the Computer Tomography system further comprises a reconstructing unit which is adapted to reconstruct a first image from the first image data set and which is further adapted to reconstruct a second image from the second data set. The reconstruction unit may be a single reconstruction unit but may also be formed by two separate reconstruction units, for example by two processing units or processors and the corresponding software which is adapted to reconstruct an image of the object under examination from the first image data set, e.g. acquired in a standard CT, and/or from the second image data set, e.g. acquired in a CSCT.

The reconstruction unit may be further adapted to match both reconstructed images but the matching may be as well performed by an additional unit like a matching unit. Such reconstruction and matching units are well known in the prior art. A suitable reconstruction algorithm is known from L. A. Feldkamp, L. C. Davis, and J. W. Kress, ,,Practical cone-beam algorithms“, J. Opt. Soc. Am. A 6, pp. 612-619, 1984, from K. Taguchi, and H. Aradate, ,,Algorithm for image reconstruction in multi-slice helical CT“, Med. Phys. 25, pp. 550-561, 1998 and from U.van Stevendaal, J.-P. Schlomka, A. Harding, and M. Grass, ,,A reconstruction algorithm for coherent scatter computed tomography based on filtered back-projection“, Med. Phys. 30 (9), pp. 2465-2474, September 2003, for example.

According to another embodiment, the Computer Tomography system further comprises a determination unit which is adapted to determine whether the second data set is acquired according to a predetermined criterion. In particular, the determination unit may be adapted to determine whether a region of the object may show a doubtful, unclear, suspicious or potentially dangerous item. The criterion may be in particular set in order to distinguish between regions of different absorption of X-ray radiation, e.g. to distinguish between organic and metallic material.

In single-energy CT the distinction may be based on a reconstructed density of a region of the object under examination or on a linear attenuation coefficient. In dual-energy CT the distinction may also be based on the so-called effective atomic number, which is described in detail in S. Naydenov, “Multi-energy radiography for non-destructive testing of materials and structures for civil engineering”, in Proceedings of the International Symposium on Non-Destructive Testing in Civil Engineering 2003, ISBN 3-931381, poster contribution p037.

According to another embodiment of the Computer Tomography system the determination unit is further adapted to decide, whether the second data set is to be acquired according to a predetermined criterion, in a time span which is shorter than a time span which is given by the transportation time of the object under investigation from the first scanning unit to the second scanning unit.

By adapting the determination unit in such a way it may be possible to provide an efficient way to skip a scanning by the second scanning unit in cases the first scanning unit does not exhibit a suspicious region in the bag. Thus, the throughput may be increased.

In yet another embodiment, a proposed baggage scanner comprises a CT part with an X-ray tube and a CT detector, and a CSCT part with a tube yielding a different X-ray spectrum and an energy resolving detector. All components are mounted on a single gantry. The tubes and therefore also the detectors, could have an angular distance of 90° to each other in the x-y plane, i.e. the plane which the gantry rotates and which is thus perpendicular to the axis of rotation of the gantry. Furthermore, the tubes could also have a radial distance and a certain distance to each other concerning the z-direction, i.e. the direction which substantially coincide with the axis of rotation. Such a system and the corresponding method may be used in the medical field, e.g. as an add-on for standard CT, and in baggage applications for unambiguous and fast material identification.

These and other aspects of the invention will be apparent from and elucidated with reference to the embodiments described hereinafter.

### BRIEF DESCRIPTION OF DRAWINGS

Embodiments of the present invention will now be described, by way of example only, and with reference to the following drawings, in which:

FIG. 1 shows a simplified schematic view of a geometry for energy resolved coherently scattering Computer Tomography;

FIG. 2 shows a simplified schematic scanner geometry of a combined CT/CSCT baggage scanner geometry in the x-y plane according to an exemplary embodiment; and

FIG. 3 shows a simplified schematic scanner geometry of a combined CT/CSCT baggage scanner geometry in the x-z plane according to an exemplary embodiment.

### DETAILED DESCRIPTION OF EMBODIMENTS

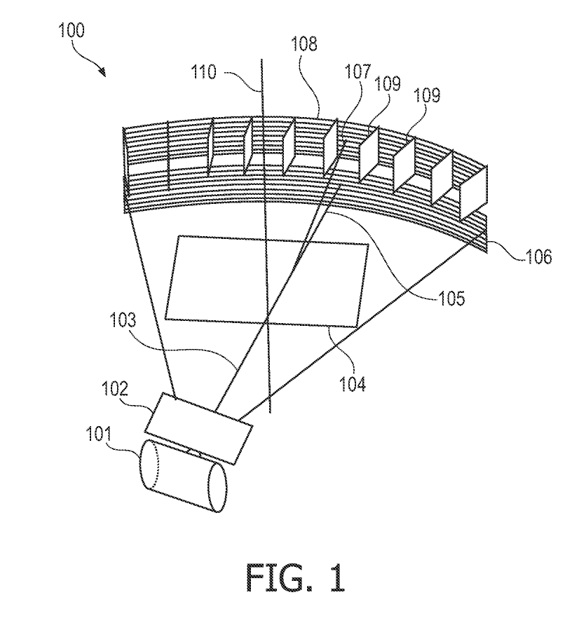

FIG. 1 shows a schematic representation of a schematic view of a geometry for energy resolved coherently scattering Computer Tomography. The CT system 100 comprises an X-ray tube 101 including a fan beam collimator 102. The X-ray tube emits radiation, which is schematically shown by the line 103. An object 104 under examination, e.g. a suitcase or another piece of baggage, is schematically depicted in the radiation direction. The radiation emitted by the X-ray tube partially passes the object under examination 104 which part 105 is attenuated by the object and impinges on a CT-detection unit 106, which comprises a number of detection elements. A second part of the emitted radiation is scattered by the object 104, which scattered part is schematically depicted by the line 107. This scattered part impinges a coherently scattering Computer Tomography (CSCT) detector unit 108. The CSCT detector unit 108 comprises so-called 1D scatter collimators 109. Furthermore, an axis of rotation of the CT/CSCT system is indicated by the line 110. In operation the CT-detection unit 106, which may be a single line or multi line detection unit, detects the directly transmitted radiation, while the CSCT detector unit 108 is placed offset in respect to the emitted radiation in order to detect the radiation coherently scattered by the object, and may comprise energy-resolving detection elements. In operation a narrow fan-beam with small divergence in the out of fan plane direction or a focused fan-beam penetrates an object and the transmitted radiation as well as the radiation scattered in the direction out of the fan plane is detected.

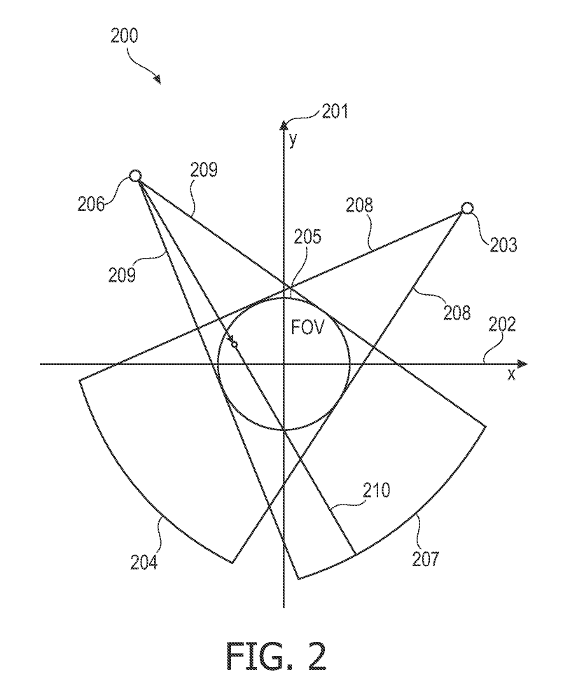

FIG. 2 shows a simplified schematic scanner geometry of a combined CT/CSCT baggage scanner 200 according to an exemplary embodiment. FIG. 2 shows a cross section of the CT/CSCT system perpendicular to the axis of rotation, i.e. to the z-direction, so that FIG. 2 represents a cross section in the x-y plane wherein the corresponding coordinate system is schematically depicted by the arrows 201 and 202. The CT/CSCT system 200 comprises a first X-ray tube 203 and a corresponding X-ray detection unit 204, which are adapted to emit and to detect radiation, respectively, which is transmitted through an object under examination which is schematically shown as a circle 205. The CT/CSCT system 200 further comprises a second scanning unit, comprising a second X-ray tube 206 and a second X-ray detection unit 207 which are adapted to emit and to detect radiation, respectively, which is scattered by the object under examination. The second X-ray detection unit 207 is arranged off-centre in respect to the z-direction in order to detect the scattered radiation. The corresponding fields of view of the two scanning units are schematically depicted as lines 208 and 209, respectively. Furthermore, a radiation beam emitted by the second X-ray tube 206 and scattered by the object under examination is schematically shown and labeled with reference sign 210. As can be seen in FIG. 2 the two scanning units, i.e. the two X-ray tubes and also the corresponding detection units, have an angular distance of about 90° in respect to each other. Preferably, both scanning units are arranged on a single gantry.

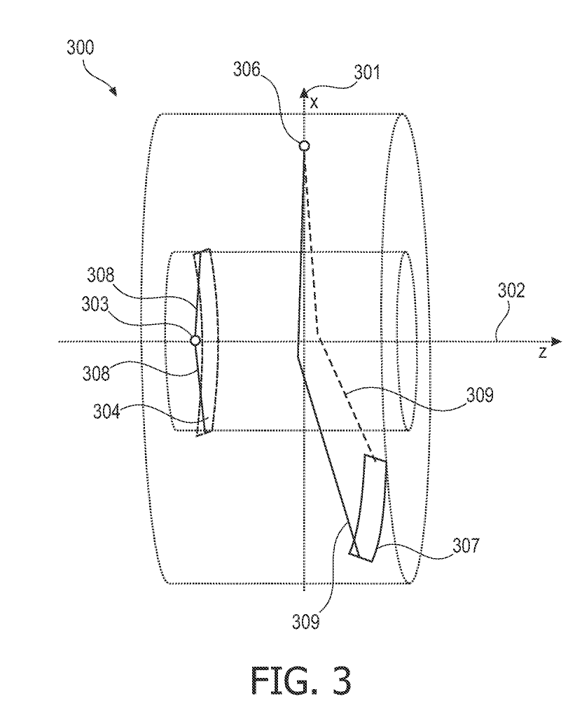

FIG. 3 shows a simplified schematic scanner geometry of the combined CT/CSCT baggage scanner 300, wherein the FIG. 3 shows the scanner in the x-z plane, which is schematically shown by the x-coordinate 301 and the z-coordinate 302. The CT/CSCT system 300 comprises a first X-ray tube 303 and a corresponding X-ray detection unit 304, which are adapted to emit and to detect radiation, respectively, which is transmitted through an object under examination. The CT/CSCT system 300 further comprises a second scanning unit, comprising a second X-ray tube 306 and a second X-ray detection unit 307 which are adapted to emit and to detect radiation, respectively, which is scattered by the object under examination. The second X-ray detection unit 307 is arranged off-centre in respect to the z-direction in order to detect the scattered radiation. The corresponding fields of view of the two scanning units are schematically depicted as lines 308 and 309, respectively. As can be seen in FIG. 3 the two scanning units, i.e. the two X-ray tubes and also the corresponding detection units, have an offset to each other in the z-direction as well as an offset to each other in respect to the radial direction. However, both scanning units are preferably arranged on a single gantry. All the different offsets, i.e. in z-direction, in the radial direction, and in the Φ-direction can be chosen independently. In operation the object under examination preferably is scanned by the standard CT scanning unit first and afterwards by the CSCT scanning unit.

Summarizing it may be seen as one aspect of the present invention that a combined Computer Tomography system is provided which comprises two scanning units, each comprising an X-ray tube and an X-ray detection unit, wherein the first scanning unit is adapted to perform a standard or transmitting Computer Tomography, while the second scanning unit is adapted to perform a coherently scattering Computer Tomography. Such a combined Computer Tomography system may be used for material identification in the case of baggage inspection application and in medical applications for detection of diseases, which modify the molecular structure of tissue.

From reading the present disclosure, other variations and modifications will be apparent to the skilled person. Such variations and modifications may involve equivalent and other features which are already known in the art of X-Ray apparatus, baggage inspection and medical scanning, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination.

The applicant hereby gives notice that new claims may be formulated to such features and/or combination of such features during the prosecution of the present application or of any further application derived therefrom.

For the sake of completeness it is also stated that the term “comprising” does not exclude other elements or steps, the term “a” or “an” does not exclude a plurality, and reference signs in the claims shall not be construed as limiting the scope of the claims.

1. A Computer Tomography (100) system for examining an object, comprising:
a gantry;
a first X-ray tube (303);
a second X-ray tube (306);
a first X-ray detection unit (304); and
a second X-ray detection unit (307),
wherein first X-ray detection unit (304) is adapted to acquire a first data set by detecting radiation emitted by the first X-ray tube (303) after passing through the object under examination;
wherein the second X-ray detection unit (307) is adapted to acquire a second data set by detecting radiation emitted by the second X-ray tube (306) and after being coherently scattered by the object under examination;
wherein the first X-ray tube (303), the second X-ray tube (306), the first X-ray detection unit (304) and the second X-ray detection unit (307) are adapted to be rotatable around the object under examination; and
wherein the first X-ray tube (303), the second X-ray tube (306), the first X-ray detection unit (304) and the second X-ray detection unit (307) are adapted to be rotatable around a common axis; and
wherein the first X-ray tube. the second X-ray tube, the first X-ray detection unit and the second X-ray detection unit are mounted on the gantry.

2. The Computer Tomography system (300) according to claim 1, wherein the first X-ray detection unit (304) comprises a plurality of detector elements. and wherein the second X-ray detection unit comprises a plurality of detector elements.

3. (canceled)

4. The Computer Tomography system (300) according claim 1, further comprising:
a high voltage generator, wherein the voltage generator is adapted to supply power to operate the first X-ray tube (303) and wherein the voltage generator is further adapted to supply power to operate the second X-ray tube (306).

5. (canceled)

6. The Computer Tomography system (300) according to claim 15, wherein the first X-ray tube (303) and the second X-ray tube (306) are displaced relative to each other.

7. The Computer Tomography system (300) according to claim 6, wherein the displacement is in the direction of the common axis.

8. The Computer Tomography system (300) according to claim 6, wherein the displacement is in the Φ-direction.

9. The Computer Tomography system (300) according to claim 8, wherein the displacement in the Φ-direction is between 60° and 120°.

10. The Computer Tomography system (300) according claim 6, wherein the displacement is in a radial direction with reference to the rotation.

11. The Computer Tomography system (300) according to claim 1, further comprising:
a transporting device adapted to transport the object under examination through a region around which the first X-ray tube (303), the second X-ray tube (306), the first X-ray detection unit (304) and the second X-ray detection unit (307) are rotatable.

12. The Computer Tomography system (300) according to claim 1, further comprising:
a reconstructing unit adapted to reconstruct a first image from the first data set and a second image from the second data set.

13. The Computer Tomography system (300) according to claim 1, further comprising:
a determination unit adapted to determine whether the second data set is acquired according to a predetermined criterion, wherein the determination unit is further adapted to determine, whether the second data set is acquired according to a predetermined criterion, in a time span which is shorter than a time span which is given by the transportation time of the object under investigation from the first scanning unit to the second scanning unit.

14. (canceled)

15. A method for acquiring image data of an object under examination using a Computer Tomography system (300) which comprises a gantry, a first X-ray tube (303), a second X-ray tube (306), a first X-ray detection unit (304), and a second X-ray detection unit (307), wherein the first X-ray detection unit (304) is adapted to acquire a first data set by detecting radiation emitted by the first X-ray tube (303) after passing through the object under examination, and wherein the second X-ray detection unit (307) is adapted to acquire a second data set by detecting radiation emitted by the second X-ray tube (306) and after being coherently scattered by the object under examination, wherein the first X-ray tube (303), the second X-ray tube (306), the first X-ray detection unit (304) and the second X-ray detection unit (307) are rotatable around the object under examination, and-wherein the first X-ray tube (303), the second X-ray tube (306), the first X-ray detection unit (304) and the second X-ray detection unit (307) are rotatable around a common axis, and wherein the first X-ray tube (303), the second X-ray tube (306). the first X-ray detection unit (304) and the second X-ray detection unit (307) are mounted on the gantry, the method comprising:
acquiring a first data set indicative of the object under examination by detecting radiation emitted by the first X-ray tube after passing through the object under examination by the first X-ray detection unit; and
acquiring a second data set indicative of the object under examination by detecting radiation emitted by the second X-ray tube (306) and after being coherently scattered by the object under examination by the second X-ray detection unit.

16. The method according claim 15, further comprising:
determining whether the second data set is acquired according to a predetermined criterion in a time span which is shorter than a time span which is given by the transportation time of the object under investigation from the first scanning unit to the second scanning unit.

17. (canceled)

18. A computer readable medium in of-on which a computer program for acquiring image data of an object under examination is provided, the program performing the method according to claim 15.

19. (canceled)
